(19) United States
(12) Patent Application Publication
(10) Pub. No.: US 2005/0065250 A1
(43) Pub. Date: Mar. 24, 2005

(54) Inorganic antiblock

(76) Inventor: Donna Sue Davis, Beaumont, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 10/669,213

(22) Filed: Sep. 24, 2003

(51) Int. Cl. C08J 3/00

(52) U.S. Cl. 524/230; 524/563; 524/556

(57) ABSTRACT

The invention concerns the use of fatty acid amides as antiblock additives for film-forming compositions, eliminating the necessity of inorganic additives.

### FIELD OF THE INVENTION

The invention relates to antiblock agents for film forming compositions.

### BACKGROUND OF THE INVENTION

Inorganic particles such as talc or silica are known to be useful additives to film-forming compositions, such as compositions comprising ethylene vinyl acetate (EVA). These inorganic additives are described in the prior art as providing various benefits to the final film product or the processing thereof, including as antiblock agents, agents to reduce the coefficient of friction (COF), as nucleating agents, and the like, depending on the quantity used, coadditives, and the nature of the base material to which they are added.

Low melting point films comprising EVA, plastomers, and other polymers are sometimes used to package additive compositions (add-packs) for other compositions. Such packages are particularly useful in the case where the entire package is simply thrown into the base composition. The film packaging itself dissolves or otherwise disperses into the base composition along with the add-pack composition contained within it.

U.S. Pat. No. 4,510,281 describes the combination of EVA copolymers with certain oleamides to provide tack-free pellets for industrial end uses. The oleamides and other esters described therein as additives improve the free-flowing properties of the pellets by incorporating into the polymer material, prior to pelletization, about 500-10,000 parts per million (ppm), based on the polymer weight of an additive selected from the group consisting of N,N′ethylenebisoleamide (EBO), N,N′-ethylenebiserucamide, N,N′diolelyladipamide, and N,N′-dierucyladipamide.

U.S. Pat. No. 5,661,201 relates to a thermoplastic film including at least one ethylene copolymer and at least one N,N′-ethylenebisamide in order to obtain a film capable of being sealed by a high-frequency current. Disclosed N,N′-ethylenebisamides include N,N′ethylenebisstearamide (EBS) and the aforementioned EBO, the latter being most preferred. One preferred ethylene copolymer is EVA having a vinyl acetate content preferably between 12 wt. % and 28 wt. %, not to exceed 40 wt. %. Antiblocks may be added, chosen from fatty acid primary amides, silica, talc, or a mixture thereof, with the preferred antiblock being erucamide, employed in an amount not to exceed 2 wt. % relative to the thermoplastic film.

U.S. Pat. No. 6,528,174 relates to a polymeric film forming composition comprising an ethylene copolymer having a percentage of vinyl acetate monomer incorporated at 10 wt. % or higher relative to the ethylene, an olefinic bisoleamide described in the patent. The preferred bisoleamide is EBO and the relative weight percentage of olefinic bisoleamide to the ethylene copolymer ranges from 200-10,000 ppm. See also WO 98/14512.

Other patents of interest include U.S. Pat. Nos. 6,120,899; 5,942,569; 5,695,881; 4,510,281; 4,477,523; 4,349,605; and Re. 32,325.

In both U.S. '201 and '174, above, all the examples use inorganic materials—e.g., silica—as well as the specified amides. See also U.S. Patent Applications Nos. 2003/0036592 and 2003/0049438. It has otherwise been recognized that most amides will improve blocking when used in combination with inorganic materials. See March 2002 Crodamide™ product brochure from Croda™.

However, the present inventor has recognized that inorganic additives may be detrimental for various reasons, such as incompatibility with certain base compositions or because of the negative effect of inorganic particulates in the end use, the latter problem notable in a wide variety of end uses, from lubricants for fine machinery to trailer hitch attachments. The present inventor has surprisingly discovered that certain fatty acid amides can serve the same function as the inorganic particulates as an antiblock at the same time eliminates the need for such inorganic additives.

### SUMMARY OF THE INVENTION

The invention concerns the use of fatty acid amides in polyolefin compositions. In an embodiment the polyolefin composition does not contain inorganic additives, such as silica, talc, TiO₂, and the like.

In another embodiment, the invention concerns the use of fatty acid amides selected from N,N′-ethylenebisoleamide (hereinafter “EBO”), N,N′ethylenebisstearamide (hereinafter “EBS”), erucamide, stearamide, behenamide, oleamide, and mixtures thereof, as antiblock agents and/or agents to reduce the coefficient of friction (COF), in film-forming compositions comprising polyolefins.

In a preferred embodiment, the invention concerns the use of the aforementioned fatty acid amides in polyolefin compositions comprising polyethylene, including polyethylene copolymers. In a more preferred embodiment the composition the polyolefin comprises a polyethylene copolymer containing at least one vinyl ester of a saturated carboxylic acid, such as vinyl acetate.

In yet another embodiment, the invention concerns pellets produced using compositions described in the aforementioned embodiments, including the preferred and more preferred embodiments.

In still another embodiment, the invention concerns products such as films produced from the compositions and/or pellets described above.

Additional embodiments concern combinations of one or more of the above embodiments and also embodiments drawn to secondary products produced using the compositions and/or pellets, e.g., packages comprising the films, and also tertiary products, e.g., add-packs comprising the packaging made from the films and ingredients contained in the packaging, such as lubricant compositions.

The absence of inorganic particles allows the use of compositions according to the present invention in preparing films that do not contain inorganic particles, which in turn allows the preparation of packaging that does not contain inorganic particles, so that add-packs comprising the aforementioned packaging material and a lubricant (as a non-limiting example) can be provided to facilitate the delivery of a lubricant, all of which are objects of the invention.

These and other objects, embodiments, features, and advantages will become apparent as reference is made to the following detailed description, examples, and appended claims.

### DETAILED DESCRIPTION

According to an embodiment of the invention, there is provided a composition comprising a polyolefin and a fatty acid amide. In a preferred embodiment, the composition does not contain any inorganic particles. In another preferred embodiment, the composition does not contain any inorganic particles known in the art to be useful as antiblock agents, such as silica, talc, titania, and the like.

In an embodiment, the fatty acid amides are selected from erucamide, stearamide, EBO, EBS, behenamide, oleamide, and mixtures thereof. The preferred fatty acid amide is selected from EBO, EBS, and a mixture thereof. These fatty acid amides are commercially available, often with other fatty acid amides present in minor amounts. This is acceptable for the purposes of the present invention.

The amount of fatty acid amide to add is an amount sufficient to provide increased antiblock characteristics in a film formed from the composition, which may vary depending on the specific composition of the film and the film thickness. Thus, as used herein, the term “an effective amount” means an amount sufficient to provide increased antiblock characteristics in a film formed from the composition, relative to the antiblock characteristics of the film not containing the fatty acid amide or an inorganic antiblock. This implies that there is an upper limit to the amount of antiblock to add, beyond which no improvement is seen in the antiblock characteristics of the film. In an embodiment the total fatty acid amide content is from about 100 ppm to about 6000 ppm, more preferably from about 500 ppm to about 5000 ppm, based on the total composition.

It is important to recognize that, while not wishing to be bound by theory, these organic antiblock function by migrating to the surface of the film to provide the antiblock characteristics. Consequently, the ratio of the surface area to the volume of the film is important in determining how much additive is needed. For thicker films, less additive is needed, and for thinner films, more additive is needed, on a weight basis. Inorganic antiblock does not exhibit a similar effect.

In an embodiment, the polyolefin composition is selected from film-forming resins and preferably is selected from polyethylene, polypropylene, copolymers and terpolymers of polyethylene and polypropylene, and mixtures thereof.

Polyethylene is an attractive component to use in collation shrink film. Various types of polyethylenes are known in the art. Low density polyethylene (“LDPE”) can be prepared at high pressure using free radical initiators and typically has a density in the range of 0.916-0.940 g/cm³. LDPE is also known as “branched” or “heterogeneously branched” polyethylene because of the relatively large number of long chain branches extending from the main polymer backbone. Polyethylene in the same density range, i.e., 0.916 to 0.940 g/cm³, which is linear and does not contain large quantities of long chain branching is also known; this “linear low density polyethylene” (“LLDPE”) can be produced with conventional Ziegler-Natta catalysts or with metallocene catalysts. Relatively higher density LDPE or LLDPE, typically in the range of 0.928 to 0.940 g/cm³ are sometimes referred to as medium density polyethylene (“MDPE”) or Linear Medium Density Polyethylene (MDPE). Polyethylenes having still greater density are the high density polyethylenes (“HDPEs”), i.e., polyethylenes having densities greater than 0.940 g/cm³, and are generally prepared with Ziegler-Natta catalysts, chrome catalysts or even metallocene catalysts. Very low density polyethylene (“VLDPE”) is also known. VLDPEs can be produced by a number of different processes yielding polymers with different properties, but can be generally described as polyethylenes having a density less than 0.916 g/cm³, typically 0.890 to 0.915 g/cm³ or 0.900 to 0.915 g/cm³.

In an embodiment the polyolefin may be a homopolymer, or it may be a copolymer. Included in the definition of copolymer for the purposes of this invention are terpolymers and even higher order resins having a greater number of different monomers incorporated into the polymer.

In the case of polyethylene, the copolymers may be, for example, polyethylene and one or more comonomers selected from, as non-limiting examples, hexene, butene, octene, carbon monoxide, vinyl esters such as vinyl acetate, alkyl acrylates or methacrylates, maleic anhydride or glycidyl (meth)acrylate, and the like.

A preferred composition is (i) a copolymer of ethylene and of at least one vinyl ester of a saturated carboxylic acid containing 2 to 6 carbon atoms, (ii) a copolymer of ethylene and of at least one alkyl acrylate or methacrylate in which the alkyl group contains from 1 to 10 carbon atoms, (iii) the above copolymers further copolymerized with maleic anhydride or glycidyl (meth)acrylate, or (iv) the mixtures of at least two of the above mentioned copolymers.

A more preferred comonomer is vinyl acetate (i.e., EVA), and an even more referred embodiment is EVA consisting of 10-40 wt. %, yet even more preferably 12-33 wt. %, and most preferably 15-33 wt. % vinyl acetate units. In another embodiment, EVA consisting of 28-29 wt. % vinyl acetate units is used.

Other preferred comonomers include ethylene methacrylate, and ethylene normal butyl acrylate.

The polyolefin composition may also comprise polypropylene, which may be a homopolymer of polypropylene or a random or block copolymer of polypropylene, or blends thereof. The homopolymer may be atactic polypropylene, isotactic polypropylene, syndiotactic polypropylene and blends thereof. Such blends may include so-called impact copolymers, elastomers, and plastomers, any of which may be physical blends or in situ blends of polypropylene and one or more polypropylene copolymers. Preferred comonomers in the polypropylene copolymers include monomers selected from ethylene and C₄ to C₂₀ alpha-olefin derived units.

In an embodiment, the resin composition may be a mixture of various types of polyolefins, including a conventional film-forming polyolefin such as polyethylene and/or polypropylene with a material not conventionally formed into a film by itself, such as an ethylene elastomers, which are polymers comprising ethylene and propylene. The composition may also comprise ionomers such as polyethylenes or ethylene copolymer ionomers.

The polyolefin may be produced using any known catalyst system for producing polyolefins, e.g., Zeigler-Natta or metallocene catalysts, and can be made by, for instance, slurry, solution, or gas phase processes.

In an embodiment, the polyolefin is a metallocene-catalyzed polyolefin. As used herein, the term “metallocene catalyst” is defined to be at least one metallocene catalyst component containing one or more substituted or unsubstituted cyclopentadienyl moiety (Cp) in combination with a Group 4, 5, or 6 transition metal (M).

The metallocene catalyst precursors generally require activation with a suitable co-catalyst, or activator, in order to yield an “active metallocene catalyst”, i.e., an organometallic complex with a vacant coordination site that can coordinate, insert, and polymerize olefins. The active catalyst systems generally includes not only the metallocene complex, but also an activator, such as an alumoxane or a derivative thereof (preferably MAO), an ionizing activator, a Lewis acid, or a combination thereof. Alkylalumoxanes are additionally suitable as catalyst activators

The catalyst system is preferably supported on a carrier, typically an inorganic oxide or chloride or a resinous material such as polyethylene.

In another embodiment, the polyolefin is produced using a Zeigler-Natta catalyst. In some cases this is more preferred since these polyolefins tend to be blockier than metallocene-catalyzed polyolefins.

The aforementioned catalysts and processes are well known in the art, and are described in, for example, ZIEGLER CATALYSTS (Gerhard Fink, Rolf Mulhaupt and Hans H. Brintzinger, eds., Springer-Verlag 1995); Resconi et al., Selectivity in Propene Polymerization with Metallocene Catalysts, 100 CHEM. REV. 1253-1345 (2000); and 1, II METALLOCENE-BASED POLYOLEFINS (Wiley & Sons, 2000), and numerous patents, such as WO 96/11961; WO 96/11960; U.S. Pat. Nos. 4,808,561; 5,017,714; 5,055,438; 5,064,802; 5,124,418; 5,153,157; 5,324,800; more recent examples are U.S. Pat. Nos. 6,380,122; and 6,376,410; and WOO 1/98409, and references cited therein.

Additional ingredients that are normally added to such compositions, depending on the end use, may be added. Suitable additives include: antioxidants (e.g., hindered phenolics such as IRGANOX™ 1010 or IRGANOX™ 1076 available from Ciba-Geigy); phosphites (e.g., IRGAFOS™ 168 available from Ciba-Geigy); tackifiers, such as polybutenes, terpene resins, aliphatic and aromatic hydrocarbon resins, alkali metal and glycerol, stearates and hydrogenated rosins; UV stabilizers; heat or thermal stabilizers; release agents; anti-static agents; pigments; colorants; dyes; waxes; and the like.

While inorganic agents such as talc, silica, and the like, may be present in certain embodiments of the invention, as discussed above it is an object of the present invention to provide a composition wherein no additional antiblock agent or agent for the improvement of the coefficient of friction (COF) is necessary. Accordingly, in an embodiment, the composition according to the present invention contains no inorganic additives. In another embodiment, the composition according to the present invention contains no inorganic additives for the purpose of improving antiblock and/or COF.

In another embodiment, the composition according to the present invention is formed into pellets. Pelletization of polyolefins per se is well-known in the art, e.g., see U.S. Pat. No. 6,474,969. The ingredients for the resin composition to be pelletized may be blended using conventional equipment and methods, such a by dry blending the individual components and subsequently melt mixing in a mixer, or by mixing the components together directly in a mixer, such as a Banbury mixer, a Haake mixer, a Brabender internal mixer, or a single or twin-screw extruder including a compounding extruder and a side-arm extruder used directly or indirectly downstream of a polymerization process. The composition may then be extruded into pellets, for instance by using an underwater pelletizer as set forth in the aforementioned U.S. Patent.

Compositions according to the present invention are particularly suitable for film applications. They may be used to form cast or blown films having a single layer or multiple layers. A single layer comprising a composition according to the present invention may be combined, as for instance by coextrusion, with one or more other layers having the same or different composition. Thus, each layer may be individually formulated. The resultant single or multilayer film may then be formed into packaging to form an add-pack, according to the present invention, by methods known to one of ordinary skill in the art.

The compositions according to the present invention may advantageously be used for other purposes, such as coatings.

Film-forming techniques, coating processes, and other methods of using compositions according to the present invention are well known to the ordinary artisan and are described in numerous patents, such as WO98/14512 and WO01/98409.

### EXAMPLES

The following examples are meant to illustrate the present invention. Numerous modifications and variations are possible, and it is to be understood that within the scope of the appended claims, the invention may be practiced otherwise than as specifically described herein.

Table 1 sets forth the composition of film samples (2 mil thickness) prepared on a Killion cast film extruder using LD-721.1K, a commercially EVA having 19.3 wt. % vinyl acetate component and a 2.5 MI, available from ExxonMobil Chemical Company, Baytown, Tex. No additives other than an antioxidant were used. The fatty acid amide additive (if any) in the film produced is identified along with the amount used (in parts per million, ppm) and the reblock measured in the standard PLMP reblock test (ASTM D 3354-96) on film samples aged for approximately 16 hours in a 50° C. oven. This method measures the degree of blocking (adhesion) which can exist between layers of film. The degree of blocking is expressed as the grams of force required to separate two parallel plates which have been wrapped with the sample film.

The procedure used to test reblock is as follows. An area of the sample which is reasonably free from wrinkles, creases and contamination was selected (care was taken not to touch the surface of the film to be tested). Due to slight variations of gauge and blocking tendencies, several sample locations across the width of the film were selected. The film was folded so that the surfaces to be tested are in contact.

Using a 4″×7″ cutting die, 5 pairs of specimens from each sample were cut with a 7″ dimension in the machine direction. The pairs of specimens were stacked, with a 4″×7″ piece of stiff, plain paper between each pair, not to exceed 25 pairs (5 samples, 5 pairs of specimens per sample). This was to insure that heat penetrates to the center of the stack. There is room in the oven for two stacks of samples making a total of 50 pairs (10 samples, 5 pairs of specimens per sample).

The blocking weight (equilibrated at the oven temperature) was removed from the oven. The samples were placed in the oven and the blocking weight was placed on top of the stack of samples, with care taken that sample edges were aligned as closely as possible. The cut specimens were then oven aged for approximately 16 hours in a 50° C. oven.

The samples were removed from the oven after the 16 hour period and allowed to condition at 23±2° C. and 50±5% relative humidity for 24 hours. Care was taken not to flex the stack so as to break the blocking of the specimens to be tested.

The reblock test was performed in accordance with the Kayeness Block-Reblock Tester instructions and the number recorded is the average of 5 samples.

TABLE 1

| Eruca- | | | | | | |
|---|---|---|---|---|---|---|
| mide | Stearamide | EBO | EBS | Behenamide | Oleamide | Reblock |
| 0 | 0 | 0 | 0 | 0 | 0 | 180.1 |
| 0 | 0 | 2000 | 2000 | 0 | 0 | 10.6 |
| 0 | 0 | 2000 | 2000 | 0 | 0 | 25.2 |
| 0 | 0 | 4000 | 0 | 0 | 0 | 9.4 |
| 0 | 0 | 4000 | 0 | 0 | 0 | 5.8 |
| 0 | 0 | 0 | 4000 | 0 | 0 | 12.8 |
| 0 | 0 | 0 | 4000 | 0 | 0 | 13.6 |
| 2000 | 0 | 0 | 2000 | 0 | 0 | 21.4 |
| 2000 | 0 | 0 | 2000 | 0 | 0 | 18.3 |
| 0 | 4000 | 0 | 0 | 0 | 0 | 11.9 |
| 0 | 4000 | 0 | 0 | 0 | 0 | 53.0 |
| 0 | 0 | 0 | 0 | 4000 | 0 | 10.4 |
| 4000 | 0 | 0 | 0 | 0 | 0 | 124.9 |
| 4000 | 0 | 0 | 0 | 0 | 0 | 190.4 |
| 2000 | 2000 | 0 | 0 | 0 | 0 | 77.7 |
| 2000 | 2000 | 0 | 0 | 0 | 0 | 138 |
| 0 | 2000 | 2000 | 0 | 0 | 0 | 117.3 |
| 0 | 2000 | 2000 | 0 | 0 | 0 | 122.3 |
| 1000 | 1000 | 1000 | 1000 | 0 | 0 | 65.0 |
| 1000 | 1000 | 1000 | 1000 | 0 | 0 | 40.6 |
| 2000 | 0 | 2000 | 0 | 0 | 0 | 38.4 |
| 2000 | 0 | 2000 | 0 | 0 | 0 | 89.2 |
| 0 | 2000 | 0 | 2000 | 0 | 0 | 46.7 |
| 0 | 2000 | 0 | 2000 | 0 | 0 | 47.4 |
| 2000 | 0 | 0 | 0 | 0 | 2000 | 144.8 |
| 2000 | 0 | 0 | 0 | 2000 | 0 | 87.6 |
| 0 | 0 | 0 | 0 | 0 | 4000 | 203.6 |

The most effective additive was EBO with EBS also quite effective. Combinations of the two were also effective. The least effective was the lowest molecular weight oleamide. However, it was still possible to provide an improvement in antiblock, without the use of inorganic particles, using an effective amount of oleamide.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

Trade names used herein are indicated by a ™ symbol or ® symbol, indicating that the names may be protected by certain trademark rights, e.g., they may be registered trademarks in various jurisdictions.

All patents and patent applications, test procedures (such as ASTM methods), and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

1. A composition comprising: (a) at least one polyolefin; (b) at least one fatty acid amide, said composition further characterized by having no inorganic particles.

2. The composition according to claim 1, wherein said polyolefin comprises at least one polyethylene.

3. The composition according to claim 1, wherein said polyolefin comprises at least one polyethylene selected from the group consisting of (i) a copolymer of ethylene and of at least one vinyl ester of a saturated carboxylic acid containing 2 to 6 carbon atoms, (ii) a copolymer of ethylene and of at least one alkyl acrylate or methacrylate in which the alkyl group contains from 1 to 10 carbon atoms, (iii) a copolymer of (i) or (ii) further copolymerized with maleic anhydride or glycidyl (meth)acrylate, and (iv) a mixture of at least two of the copolymers of (i), (ii), or (iii).

4. The composition according to claim 1, wherein said polyolefin comprises at least one ethylene vinyl acetate.

5. The composition according to claim 4, wherein said ethylene vinyl acetate consists of 10-40 wt. % vinyl acetate units.

6. The composition according to claim 4, wherein said ethylene vinyl acetate consists of 12-33 wt. % vinyl acetate units.

7. The composition according to claim 4, wherein said ethylene vinyl acetate consists of 15-33 wt. % vinyl acetate units.

8. The composition according to claim 1, wherein said composition comprises at least one fatty acid amide selected from the group consisting of N,N′-ethylenebisoleamide, N,N′ethylenebisstearamide, erucamide, stearamide, behenamide, oleamide, and mixtures thereof.

9. The composition according to claim 1, wherein said composition comprises at least one fatty acid amide selected from the group consisting of N,N′-ethylenebisoleamide, N,N′ethylenebisstearamide, and mixtures thereof.

10. The composition according to claim 1, wherein said polyolefin comprises at least one polyethylene selected from the group consisting of (i) a copolymer of ethylene and of at least one vinyl ester of a saturated carboxylic acid containing 2 to 6 carbon atoms, (ii) a copolymer of ethylene and of at least one alkyl acrylate or methacrylate in which the alkyl group contains from 1 to 10 carbon atoms, (iii) a copolymer of (i) or (ii) further copolymerized with maleic anhydride or glycidyl (meth)acrylate, and (iv) a mixture of at least two of the copolymers of (i), (ii), or (iii); and further wherein said composition comprises at least one fatty acid amide selected from the group consisting of N,N′-ethylenebisoleamide, N,N′ethylenebisstearamide, erucamide, stearamide, behenamide, oleamide, and mixtures thereof.

11. The composition according to claim 1, wherein said polyolefin comprises at least one polyethylene selected from LLDPE, mLLDPE, and plastomers.

12. The composition according to claim 1, wherein said polyolefin comprises at least one polyethylene selected copolymers of ethylene and of at least one vinyl ester of a saturated carboxylic acid containing 2 to 6 carbon atoms, and at least one fatty acid amide selected from the group consisting of N,N′-ethylenebisoleamide, N,N′ethylenebisstearamide, and mixtures thereof.

13. The composition according to claim 12, wherein said polyolefin comprises ethylene vinyl acetate consists of 12-28 wt. % vinyl acetate units.

14. The composition according to claim 1, wherein the total fatty acid amide content is from about 100 to 6000 ppm per 2 mil thickness, based on the total composition.

15. The composition according to claim 14, wherein the total fatty acid amide content is from about 500 to 5000 ppm per 2 mil thickness, based on the total composition.

16. A method of forming a pellet comprising: (a) adding the composition according to claim 1 to a pelletizing extruder; and (b) extruding a pellet comprising said composition.

17. A pellet comprising the composition according to claim 1.

18. A film including at least one layer comprising the composition according to claim 1.

19. An article comprising a packaging material and a packaged material, said packaging material comprising a film according to claim 1, and said packaged material selected from solids, liquids and gases.

20. An article according to claim 19, wherein said packaged material includes a lubricant composition.

21. A method of forming a film comprising: (a) adding the composition according to claims 1 to a pelletizing extruder; (b) extruding a pellet comprising said composition; (c) forming a film from said pellet.

22. The method according to claim 21, wherein step (c) wherein said film is a blown film.

23. An article including a film comprising the composition according to claim 1.

24. The article according to claim 23, wherein said film encapsulates a lubricant composition.

25. A method of blending a first composition contained within an add-pack with a second composition comprising: (a) providing an add-pack comprising a packaging material and a packaged material; (b) combining said add-pack with said second composition; and (c) blending said add-pack and said second composition until said packaging material and said packaged material are dissolved or dispersed in said second composition, wherein the improvement comprises a packaging material made according to claim 21.
